(19) United States
(12) Patent Application Publication
(10) Pub. No.: US 2014/0139539 A1
(43) Pub. Date: May 22, 2014

(54) EMERGENCY DIGITAL SIGNAGE

(71) Applicant: CISCO TECHNOLOGY, INC., San Jose, CA (US)

(72) Inventor: Charles Calvin Byers, Wheaton, IL (US)

(73) Assignee: CISCO TECHNOLOGY, INC., San Jose, CA (US)

(21) Appl. No.: 13/679,424

(22) Filed: Nov. 16, 2012

(51) Int. Cl. G09G 5/10

(52) U.S. Cl. CPC G09G 5/10
USPC 345/589

(57) ABSTRACT

In one embodiment, a plurality of digital displays is connected to a backup power source and to a control computer having a processor and a memory. The memory is configured to communicate with the processor and has instructions that, in response to execution by the processor, cause the processor to determine if an emergency exists. If it is determined that an emergency exists, the processor will send a signal to the plurality of digital displays that includes instructions for the digital displays to enter an emergency mode.

### TECHNICAL FIELD

The present disclosure relates generally to digital signage, and, more particularly, to emergency modes for high density digital signs.

### BACKGROUND

Most commercial buildings are required by emergency or building codes to provide emergency illumination to assist building occupants in exiting if there is a power failure. This illumination is typically provided by an array of specialized emergency lighting fixtures attached to the ceiling of the building. These specialized emergency lighting fixtures typically consist of one or more lights that are directed where the illumination is required, a battery to run the lights for a required number of hours, and a control circuit to charge the batteries, turn on the lights when required, and monitor the system. However, these specialized emergency lighting systems are expensive to purchase, complex to install, and offer ongoing maintenance challenges.

These buildings are also required to have a number of additional networks of safety is systems, including fire alarm horns, Public Address systems to carry emergency announcements, and networks of security cameras. Installing, configuring and, maintaining these parallel networks is also complex and expensive.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example digital display;

FIG. 2 illustrates another example digital display;

FIG. 3 illustrates an example of a number of digital displays as shown in FIG. 2 mounted to shelving units in a retail environment;

FIG. 4 illustrates an example system for emergency digital signage;

FIG. 5 illustrates an example control computer;

FIG. 6 illustrates an example digital display as shown in FIG. 1 displaying an emergency message;

FIG. 7 illustrates an example simplified procedure for using emergency digital signage in an emergency lighting mode; and

FIG. 8 illustrates an example simplified procedure for using emergency digital signage in a fire alarm mode.

### DESCRIPTION OF EXAMPLE EMBODIMENTS

### Overview

According to one or more embodiments of the disclosure, a plurality of digital displays is connected to a backup power source and to a control computer having a processor and a memory. The memory is configured to communicate with the processor and has instructions that, in response to execution by the processor, cause the processor to determine if an emergency exists. If it is determined that an emergency exists, the processor will send a signal to the plurality of digital displays that includes instructions for the digital displays to enter an emergency mode.

### DESCRIPTION

As discussed above, most commercial buildings are required by emergency, building, or other codes or requirements to provide emergency illumination, fire alarms, Public Address systems, and networks of security cameras. However, installing, configuring and, maintaining these systems is complex and expensive.

These same commercial buildings are also being equipped with more and more digital displays (e.g., LCD, LED, plasma monitors or televisions, etc.) to provide information to occupants, visitors, and customers and keep them informed. One technique that some commercial buildings have used to try to supplement existing emergency and security systems is to provide basic information using these digital displays. While some of these digital signs and networks may display simple emergency information, such as a map of the building with escape routes highlighted, these current uses of the digital signs has not, and cannot currently, replace the complex and costly emergency systems discussed above. While emergency exit light fixtures themselves are well known in the art, as are LED illuminated exit signs, digital displays have never been used to provide emergency, fire, public address, or security functions.

The example systems and techniques described herein employ a number of digital displays, such as those that may already be installed in commercial buildings, connected to and controlled by a control computer to provide the emergency, security, and other functions typically provided by more complex and expensive emergency and security systems, such as emergency lighting, fire alarm, Public Announcements, security, surveillance, etc. For example, the digital signs can have high power LED backlights and control systems to turn the panels white and provide a large illumination flux to the area if AC power fails.

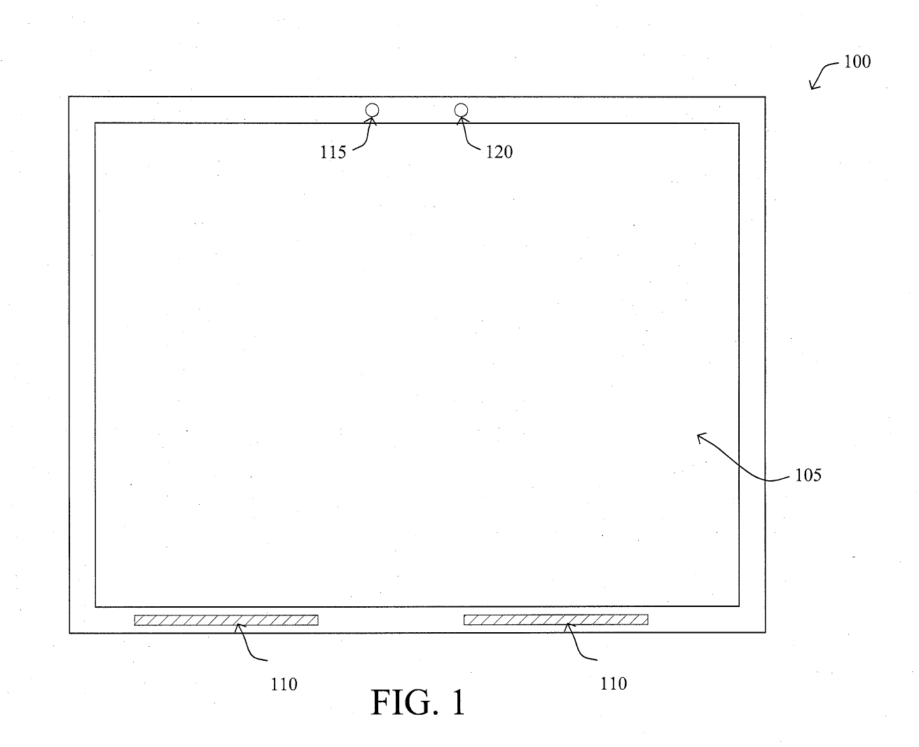

Referring to FIG. 1, according to one or more embodiments of the disclosure as described in detail below, a digital display 100 that can be used has a visible display area 105 having a standard aspect ratio of 4:3 or 16:9 and can be a LED, LCD, plasma, or other type of thin, flat panel display, but could be any type of display that will work for a particular application. Various display technologies, such as plasma, LCD, OLED, projection, and others are capable of producing the resolutions required and also of supporting the required color spaces, brightness, and aspect ratios. Digital display 100 can also have a number of additional features, such as a touch interface that would allow user input. A low resolution (approximately 8 touch points per inch) or a higher resolution touch interface could be used. Digital display 100 can also have one or more speakers 110, a camera 115, a microphone 120, a light sensor to detect ambient light levels, and/or a smoke/heat sensor. Multiple is speakers 110 can be spaced along digital display 100 and, as discussed below, could be used for various functions, such as audio feedback, directional voice prompts, fire alarms, etc. Camera 115 could be used as a security camera to monitor the spaces of the building, to monitor spaces during an emergency to determine if a building has been evacuated, to determine congestion in stairways or other areas during an evacuation or emergency, etc. Microphone 120 could be used for security to monitor sounds, interact with individuals or emergency personnel during an evacuation or emergency, etc.

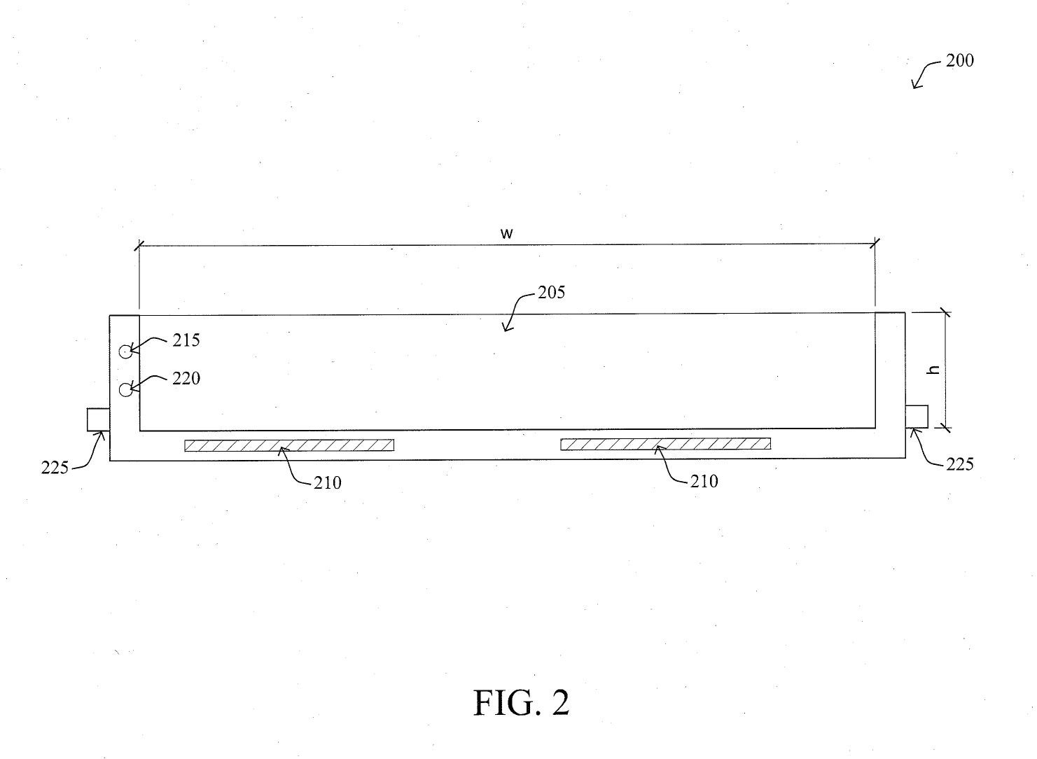

Referring to FIG. 2, another digital display 200 is shown that can be specifically used in a retail environment, which has a visible display area 205 having a height “h” of approximately 3 inches, a width “w” of approximately 48 inches, an aspect ratio of 16:1, and a pixel array of approximately 1920×120 (or a multiple thereof). Due to the unique size and aspect ratio, these digital signs 200 do not hamper visibility, block access to the products on the shelves, or take up valuable shelf space. The digital display 200 described herein may be most useful in “big box” retail environments (e.g., discount stores, grocery stores, home improvement centers, etc.), but could also be very valuable to medium and small retailers, and some service industries. This panel size and aspect ratio could be used for big box retail environments, since the shelf units are typically 48″ wide. The 3″ height should also fit well in the front of shelf space usually reserved for price tags, without hanging down too low into the volume of the next lower shelf. Digital display 200 has one or more chaining connectors 225 and is preferably a LED, LCD, plasma, or other type of thin, flat panel display, but could be any type of display that will work for a particular application, as described above for digital display 100. Digital display 200 can also have a number of additional features, such as a touch interface, one or more speakers 210, a camera 215, and/or a microphone 220, as described above for digital display 100.

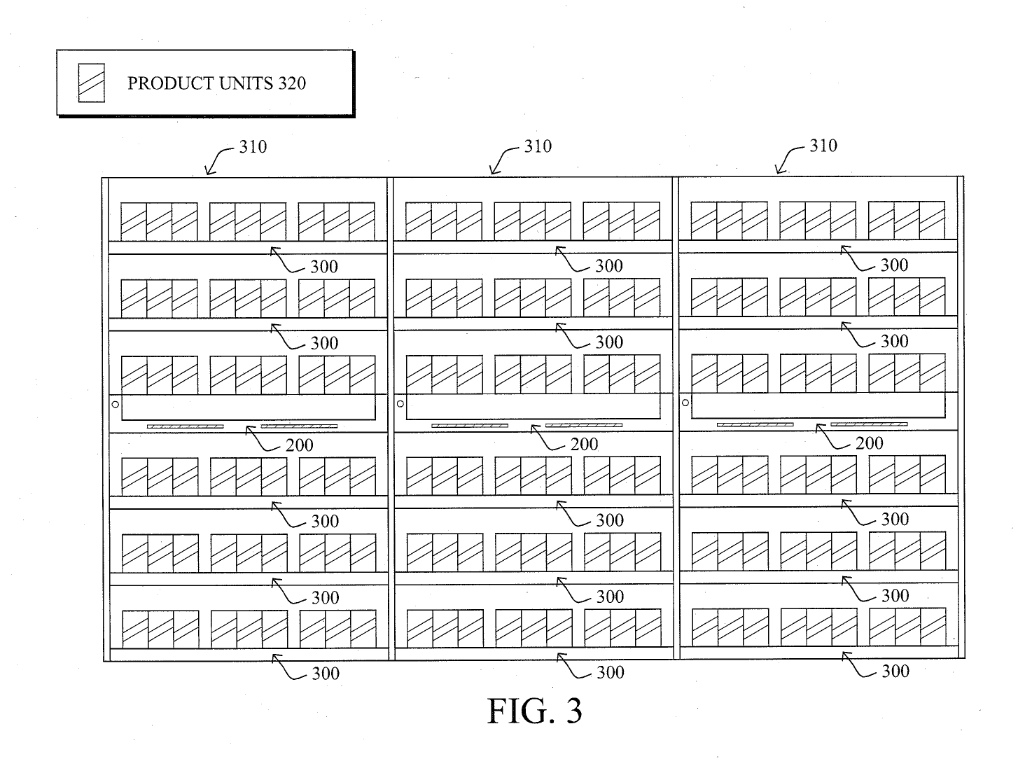

Referring to FIG. 3, a continuous band of digital displays 200 can be installed up and down each aisle of a retail store. Each digital display 200 can be installed on a shelf 300 of each shelving unit 310 at approximately eye level, which would allow the digital displays 200 to be easily observed by customers. For example, a typical “big box” retailer may have approximately 20 aisles, with each aisle being approximately 80 feet long. If each aisle were to use a continuous band of nominally 48 inch wide digital displays 200 on both sides of the aisle, to completely cover all shelf space would require forty digital displays 200 per aisle, or 800 for the entire store. Providing digital displays 200 on nearly all of the shelving units 310 of a retail store permits customers to be in close proximity to a digital display 200 no matter where they are in the store. These digital displays 200 could also be supplemented with a number of more traditional 4:3 or 16:9 aspect ratio digital displays 100 near the entrances.

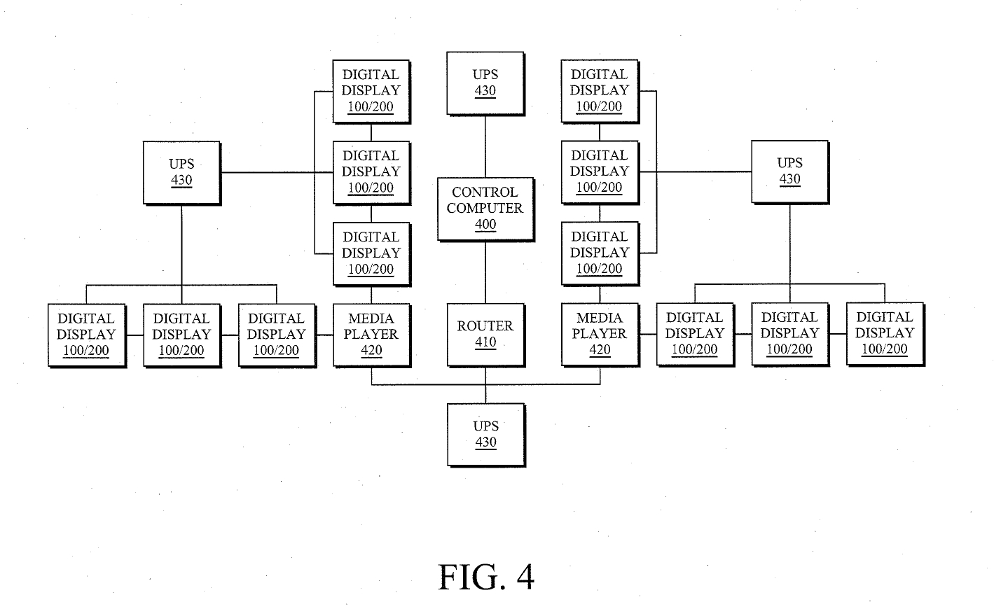

Driving digital displays 100/200 can be done by networking digital displays 100/200 with media players and routers connected to a control computer. Referring to FIG. 4, digital displays 100/200 are networked with a control computer 400 through routers 410 and media players 420 via a local network, such as a LAN. These components can also be connected to one or more backup power sources, such as uninterruptable power supplies (UPSs) 430 to provide power in the event that the main AC power is not available. Alternatively, the components can also each have their own batteries as a backup power source to provide backup power. Those skilled in the art will understand that any number of digital displays 100/200, media players 420, routers 410, control computers 400, and UPSs 430 may be used and that the view shown herein is for simplicity. Also, those skilled in the art will further understand that while the system is shown in a certain orientation, the system is merely an is example illustration that is not meant to limit the disclosure.

In a retail type environment, groups of digital displays 200 can be daisy-chained using connectors 225 and multiple groups can be connected to a media player 420. Media player 420 produces a graphic/video output, such as a conventional 1080P output, which can be driven down the chain of digital displays 200 or to each digital display 100. If a multi-head media player 420 is used in a retail environment, each media player 420 can drive enough digital displays 200 for approximately one aisle (approximately twenty media players 420 would be required for the example “big box” store described above). Media players 420 can be networked via Ethernet through routers 410 to central control computer 400, which would run the system software, calculate the graphics/video to display or audio to broadcast on all of the digital displays 100/200, and send instructions to media players 420 to render the graphics/video or audio on particular digital displays 100/200. Alternatively, media players 420 could be removed and the graphic/video and/or audio generation logic can be integrated directly into digital displays 100/200. In this example, digital displays 100/200 could be linked directly to control computer 400 and suitable routers 420 using Power Over Ethernet technology, which can provide both data and power over one cable.

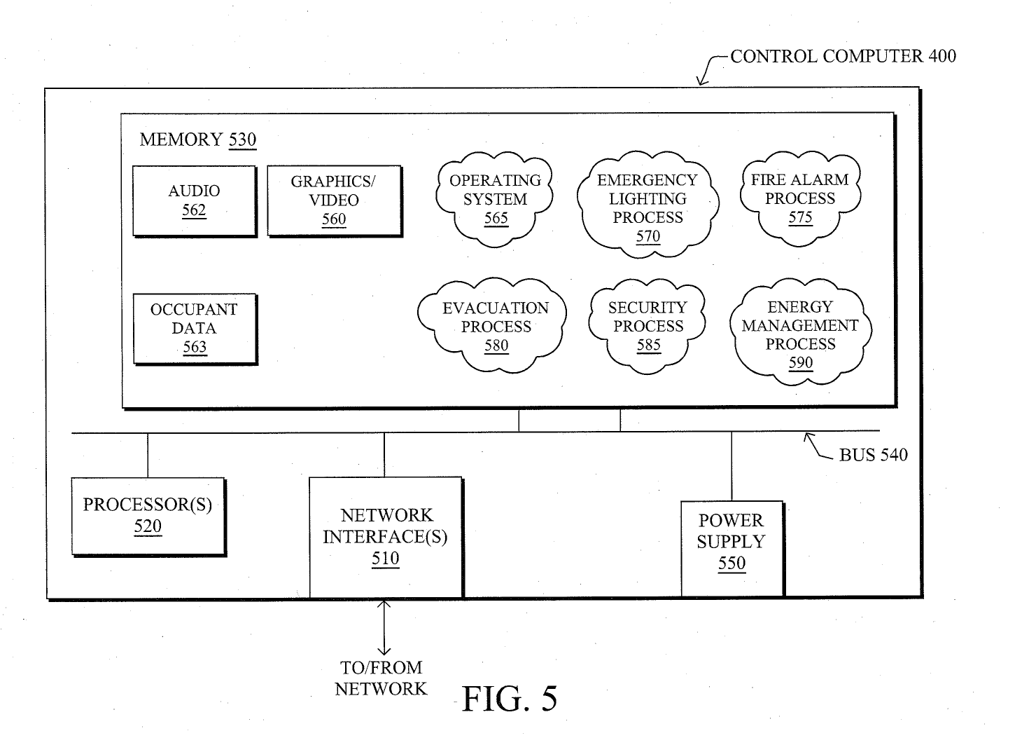

FIG. 5 is a schematic block diagram of an example control computer 400 that may be used with one or more embodiments described herein. Control computer 400 may comprise one or more network interfaces 510 (e.g., wired, wireless, power-line communication (PLC), fiber, etc.), at least one processor 520, and a memory 530 interconnected by a system bus 540, as well as a power supply 550 (e.g., battery, plug-in, etc.).

The network interface(s) 510 contain the mechanical, electrical, and signaling circuitry for communicating data to the network. The network interface(s) 510 may be configured to transmit and/or receive data using a variety of different communication protocols. Note, further, that control computer 400 may have two or more different types of network interfaces 510, e.g., wireless and wired/physical connections, and that the view herein is merely for illustration.

Memory 530 comprises a plurality of storage locations that are addressable by processor 520 and the network interface(s) 510 for storing software programs, graphics/video 560, audio 562, and occupant data 563, associated with the embodiments described herein. Processor 520 may comprise hardware elements or hardware logic adapted to execute the software programs and manipulate the graphics/video 560, audio 560, and/or occupant data 563. An operating system 565, portions of which are typically resident in memory 530 and executed by processor 520, functionally organizes the device by, inter alia, invoking operations in support of software processes and/or services executing on control computer 400. These software processes and/or services may comprise an emergency lighting process 570, fire alarm process 575, evacuation process 580, security process 585, and/or energy management process 590, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes. In addition, the techniques described herein may be performed by hardware, software, and/or firmware, which may contain computer executable instructions executed by processor 520 to perform functions relating to the techniques described herein.

The systems and techniques described herein can be used in many different service modes, such as:
emergency lighting mode;
fire alarm mode;
security mode; and
energy management mode.

Depending upon the specific building, variants of these modes can be easily programmed and dynamically changed as needed.

Emergency Lighting Mode

One example of a possible emergency mode is emergency lighting mode. Most commercial buildings over a certain square footage are required by building codes to include emergency lighting fixtures that will continue to operate even if the primary AC power supply to the building is interrupted, which facilitates the safe exit of building occupants from what would otherwise be dark internal spaces. Since digital displays 100/200, control computer 400, and the other required components can be powered by UPSs 430, internal batteries, or other backup power sources, as described above, digital displays 100/200 can be used to largely replace the expensive and difficult to maintain emergency exit lighting fixtures that are routinely used today. Therefore, no network of emergency light fixtures need be purchased, installed, or maintained in areas of a building with a large penetration of digital signs equipped to run in this mode.

In emergency lighting mode, control computer 400 or digital displays 100/200 could detect the need for emergency lighting or determine the existence of an emergency that may require emergency lighting. For example, digital displays 100/200 can monitor the AC input and send a signal to control computer 400 if the AC input for a particular digital display 100/200 drops below a predetermined voltage, which can be configured to the level at which the building's primary lighting fixtures would fail to operate. Digital displays 100/200 can also use cameras 115/215 or an ambient light sensor and send a signal to control computer 400 if the illumination drops below a certain threshold light level, which can be set based on the times of day when the building is expected to be occupied. In addition, control computer 400 can monitor the AC input and detect an AC failure or receive a signal or notification that there has been a power failure or that emergency lighting is needed.

Once control computer 400 has determined there has been a power failure or other emergency that may require emergency lighting, either by detecting the failure or receiving a signal (e.g., from digital displays 100/200), control computer 400 can use emergency lighting process 570 to send a signal to digital displays 100/200 instructing them to enter an emergency lighting mode. When used in a system such as that shown in FIG. 4, control computer 400 can send the signal to media players 420 through routers 410, which can then forward the signal to the appropriate digital displays 100/200. Alternatively, if the system does not use media players 420, such as the alternative discussed above, control computer 400 can send the signal directly to digital displays 100/200. In addition, rather than relying on control computer 400, digital displays 100/200 could each contain programming that would place digital displays 100/200 in emergency lighting mode if a digital display 100/200 were to detect the power failure.

The signal sent to digital displays 100/200 to enter emergency lighting mode can include instructions for each digital display 100/200 to increase the backlight or panel drive to maximum illumination level and paint the visible display area 105/205 with full white (or other selected emergency illumination color as appropriate), which, when activated by digital displays 100/200, will provide the maximum lighting flux into the spaces covered by digital displays 100/200. Given the high lighting flux available from modern LCD and plasma type displays typically used for digital signs, the lighting provided by digital displays 100/200 in this condition should be more than adequate to provide safe exit illumination to rooms, corridors, stair wells, basements, etc.

RS-232 control links (as are often found on high end digital displays) can also be used to control, monitor, and test the operation of the emergency lighting mode and other enhanced functions of the network of digital displays 100/200. Simple static messages (e.g., directions to the nearest exits) could also be stored in local flash memory on digital displays 100/200 and automatically rendered when emergency illumination mode is entered.

In order for digital displays 100/200 to be satisfactorily used in this manner, digital displays 100/200 may have a higher than normal maximum backlight illumination level, for example, through the use of more or higher power backlight LED arrays. In addition, UPSs 430, internal batteries, or other backup power source used by the various components should be adequate to run the system and digital displays 100/200 in emergency lighting mode for the number of standby hours required by the applicable code, regulation, and/or requirement. To assist in this, the video rendering, network interfaces, and other non-required functions of digital displays 100/200 can be placed into a deep power down mode to preserve power and maximum run time for the emergency lighting mode. Digital displays 100/200 could then revert back to a normal mode, with normal power levels, once the normal power has been restored.

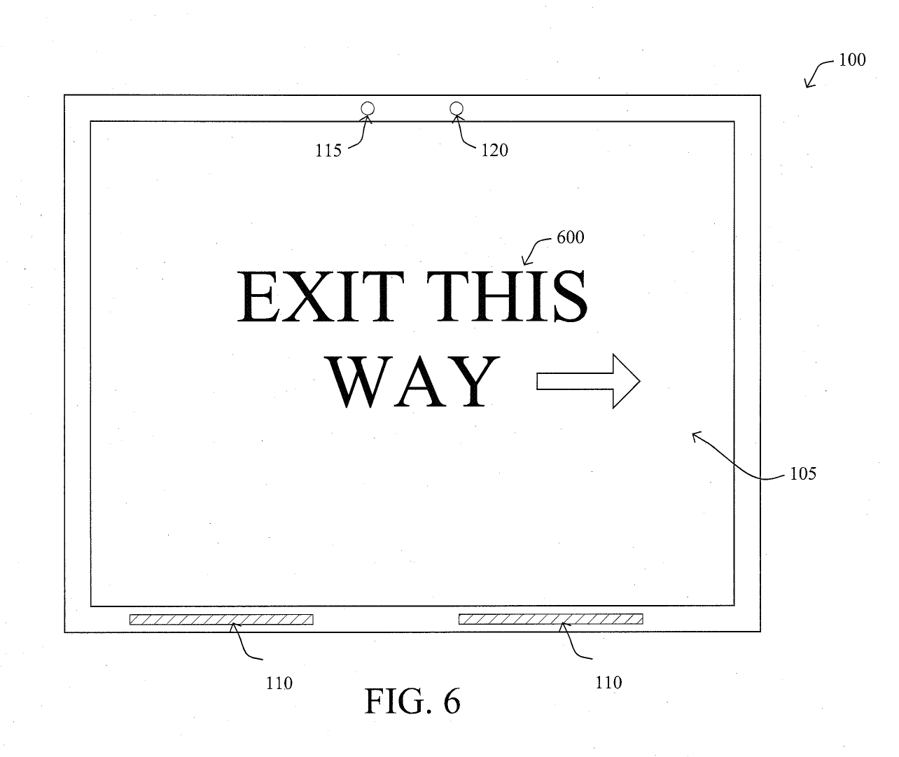

Referring to FIG. 6, while in emergency lighting mode, digital displays 100/200 can also display emergency messages 600 (e.g., EXIT THIS WAY or USE STAIRS, NOT ELEVATOR or EXIT ON GROUND FLOOR). Control computer 400 can use emergency lighting process 570 to prepare and send graphics/video 560 information related to the power outage, emergency, etc., for display by digital displays 100/200. Control computer 400 can send the information to media players 420 through router 410 or directly to digital displays 100/200, as discussed above. Media player 420 can then generate the requested graphics/video pursuant to the information received and send the corresponding graphics/video to the appropriate digital displays 100/200 or digital displays 100/200 could generate the requested graphics/video if media players 420 are not used. However, care should be taken to select fonts, design graphics, and choose rendering colors for each digital display 100/200 to insure that most of the lighting flux available from the backlight actually radiates from digital displays 100/200.

Emergency messages 600 could also include incident-specific information about the nature of the emergency or more detailed instructions to building occupants (e.g., GENERAL POWER FAILURE or SEVERE WEATHER or EARTHQUAKE or MAINTENANCE OPERATION or EVACUATION DRILL) as building occupants may react in a more controlled way if they are informed of a reason for the power failure or other emergency. Different emergency messages 600 could be given different color codes on digital displays 100/200 to help reinforce their meaning (especially if most building occupants are familiar with this feature through the practice of regular emergency evacuation drills, as are mandated in many government buildings such as schools).

While in emergency lighting mode, digital displays 100/200 can also use speakers 110/210 to provide audio emergency messages, including directions to exit routes, incident-specific information, etc. to building occupants. Control computer 400 can use emergency lighting process 570 to prepare and send audio 562 information related to the power outage, emergency, etc. for broadcast by digital displays 100/200. Control computer 400 can send the information to media players 420 through router 410 or directly to digital displays 100/200, as discussed above. Media player 420 can then generate the requested audio pursuant to the information received and send the corresponding audio to the appropriate digital displays 100/200, or digital displays 100/200 could generate the requested audio if media players 420 are not used.

Fire Alarm Mode

Another example of a possible emergency mode is fire alarm mode. If a sufficient number of digital displays 100/200 were installed, such that every occupied space in a building was within close earshot of at least one digital display 100/200, digital displays 100/200 could be used to replace both the fire alarm horns and PA systems in a building. For example, in fire alarm mode, if a fire is detected by a smoke/heat detector (traditional or integrated within digital displays 100/200), a manual pull station is activated, or an emergency icon is selected by a building occupant on digital displays 100/200, control computer 400 could receive a fire alarm signal from the smoke/heat detector, pull station, or digital display 100/200, or could receive a fire alarm signal from a fire department, security station, etc. When control computer 400 receives a fire alarm signal, control computer 400 can use fire alarm process 575 to send a signal to digital displays 100/200 instructing them to enter a fire alarm mode. Control computer 400 can also send instructions for digital displays 100/200 to enter emergency lighting mode at the same time as well, as discussed above. When used in a system such as that shown in FIG. 4, control computer 400 can send the signal to media players 420 through routers 410, which can then forward the signal to the appropriate digital displays 100/200. Alternatively, if the system does not use media players 420, such as the alternative discussed above, control computer 400 can send the signal directly to digital displays 100/200.

The signal sent to digital displays 100/200 to enter fire alarm mode can include instructions for each digital display 100/200 to disable mute mode (if enabled) and broadcast an alarm tone through speakers 110/115 at high volume to alert building occupants to evacuate. In addition, if broadcast announcements or special emergency instructions need to be broadcast, control computer 400 can use video/graphics 560 and/or audio 562 and fire alarm process 575 to send instructions to digital displays 100/200 to display particular fire alarm graphics/videos or broadcast streaming or live audio messages, acting as a building-wide public address system.

In order to comply with the Americans with Disabilities Act and similar legislation, the network of digital displays 100/200 can also be used to assist disabled building occupants during an evacuation or emergency. For example, for hearing impaired occupants, control computer 400 can send graphics/video 560 information to digital displays 100/200 to produce attention-grabbing graphics and strobe effects, similar in function to the strobe lights found on ADA compliant fire alarm horns, and/or provide text caption instructions for all lighting failures, fire alarms, announcements, etc. For visually impaired occupants, control computer 400 can send audio 562 information to digital displays 100/200 to broadcast audible cues (e.g., voice instructions or special tones to delineate right or left turns, or stairwells, etc.) to help visually impaired occupants navigate to preferred escape routes. A unique “audio animation mode” could also be used wherein each digital display 100/200 along an evacuation route could play an identifiable sound in sequence along the preferred evacuation route, creating a repeating audible trail that is easy for visually impaired occupants to follow. This could also be useful for all building occupants in circumstances where there may be heavy smoke or other visual impairments. The “audio animation mode” could be a sequence of short beeps that is played in quick succession from speakers 110/210 of each digital display 100/200 along the route with the frequency of the beeps increasing as the route nears an exit. For mobility impaired occupants, digital displays 100/200 could also include a touch screen “ADA Help” button or instructions on how to contact the appropriate authorities if they require evacuation assistance.

For digital displays 100/200 having more interactive capabilities (e.g., touch screens, speakers 110/210, cameras 115/215, facial/gesture recognition, microphones 120/220, Bluetooth connections to mobile devices, etc.), even more safety capabilities could be possible, either together with fire alarm and/or emergency lighting modes or on their own. For example, in the case of the evacuation of a large building or high rise, control computer 400 can use graphics/video 560 and evacuation process 580 (or it could be part of emergency lighting process 570 or fire alarm process 575) to send graphics/video 560 information to each digital display 100/200 to display evacuation instructions and a touch target. As evacuees file past digital displays 100/200 during the evacuation, each evacuee could touch the target indicating that they have left a designated area. When this input is received, digital displays 100/200 could send this information to control computer 400, which can compare the inputs to occupant data 563 to determine building occupancy and if there are possible occupants left in a given area or escape route. This could give first responders and security personnel a minute-by-minute account of which areas are occupied and which escape routes are operating at what capacity. If it is determined that a given escape route (e.g., a stair well) appears to be overloaded based on the number and frequency of inputs received, control computer can use evacuation process 580 to send instructions to the digital displays 100/200 upstream from the overload to display graphics/video or broadcast audio directing more evacuees to available alternate routes. In addition, if digital displays 100/200 have cameras 115/215, touching the displays may not be necessary. For example, video analytics can be used to detect the number of people moving by each digital display 100/200 and their speed along the evacuation routes and this information could be sent to control computer 400 for use in determining if an evacuation route is overloaded. With these possible options, digital displays 100/200 can be important 2-way communication devices between building occupants and first responders, similar in function to the emergency telephone found in all elevators, but spread widely across a building. If people in one part of the building are unable to evacuate (e.g., they are cut off by a fire or overwhelming smoke), the first responders can have direct two-way links with the people (including 2-way video chat if desired).

Using digital displays 200 in a setup similar to that shown in FIG. 3, additional safety modes are also possible. For example, since digital displays 200 are located with minimal space between them, the graphics/video displayed on digital displays 200 can be coordinated as a single, wide virtual screen in emergency scenarios and a continuous path animation can be created to guide building occupants or provide information. In a “big box” retail building, if emergency lighting mode or fire alarm mode were activated, an animation similar to a moving theater marquee or moving arrows can span digital signs 200 along a preferred evacuation path, down the aisles in the correct direction, and to the appropriate emergency exits. Using this technique, there should be no ambiguity on the direction building occupants should take for the most effective evacuation, regardless of their starting location in the building. Digital displays could also be used to enhance building occupant safety by displaying graphics/video and/or broadcasting audio directing occupants to stay clear of areas that may be temporarily hazardous. For example, if a forklift is doing stocking operations in one aisle, digital displays 200 could display graphics/video and/or broadcast audio instructing occupants not to enter that aisle or the aisles adjacent the restocking aisle until the forklift operations have been completed. If there is police or other activity (e.g., apprehending a shoplifter), digital signs 200 could display graphics/video and/or broadcast audio directing occupants away from the area of activity and/or guiding police or other responders to the activity. If there are spills, cleaning activities, etc. going on, digital displays 200 could display graphics/video and/or broadcast audio alerting occupants to the activity (e.g., displaying “CAUTION-WET FLOOR”).

Using the system in fire alarm mode and not having to install, test, and maintain separate networks of fire alarm horns and public address speakers, but using a reliable network of digital displays for these functions could greatly reduce the operational costs of buildings.

Security Mode

Another example of a possible mode is security mode, where digital displays 100/200 can be used as an integral part of a building's security system. For example, digital displays 100/200 having cameras 115/215 can be placed such that cameras 115/215 have good coverage of all the building's areas. Used in this manner, the need for traditional security camera networks can be reduced or even eliminated. In security mode digital displays 100/200 can use cameras 115/215 to monitor designated areas and send the video signals/feeds to control computer 400. Using security process 585, control computer 400 can then analyze the video feeds and use video analytics algorithms to detect movement, determine if people or vehicles are moving into prohibited areas, and record any potentially illegal or dangerous activities for later review and possible use as evidence. If the presence of an occupant or other movement is detected in an area of a building that should not be occupied, control computer 400 can generate an alert that is displayed to security personnel, sent to a security system or company, etc. In addition, microphones 120/220 can also be used and the audio sent to control computer 400, which can use the audio to listen for unexpected noises in areas of the building that should not be occupied.

Energy Management Mode

Another example of a possible mode is energy management mode. Digital displays 100/200 can use cameras 115/215 and/or microphones 120/220 to detect movements and/or sounds, which could act as a room occupancy sensor. The video and/or audio from cameras 115/215 and/or microphones 120/220 can be sent to control computer 400, which can use energy management process 590, and a building's energy management system, to determine occupancy of various areas and generate instructions for the energy management system to reduce lighting, air conditioning, etc., which could reduce costs for unoccupied spaces.

Even in non-emergency or security scenarios, digital signs 100/200 can be used as an important part of a building's convenience and safety systems. For example, digital displays 100/200 with touch screens, cameras 115/215, and/or microphones 120/220 can be used to communicate with control computer 400 or building personnel to request remote unlocking of doors, to report heating/cooling problems, to request maintenance or cleaning, to report suspicious activity, to ask for directions, etc. If digital displays 100/200 are pervasively installed in a building, the occupants can come to rely on them as the best way to contact the building's management and security offices.

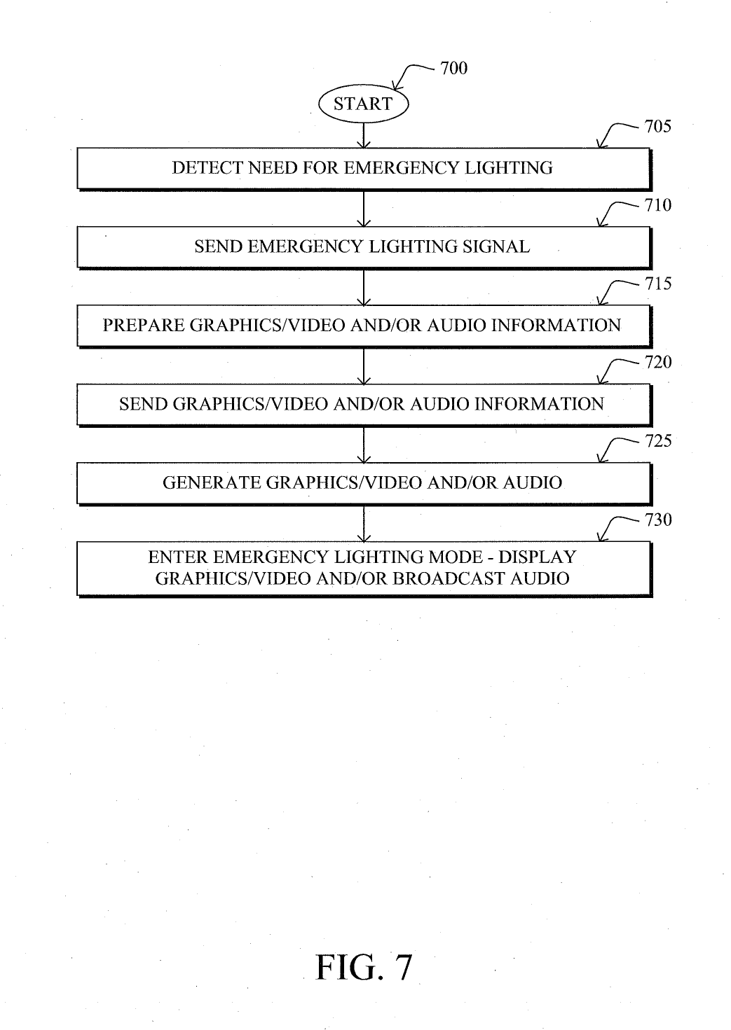

FIG. 7 illustrates an example simplified procedure for operating in emergency lighting mode in accordance with one or more embodiments described herein. The example process starts at step 700 and at Step 705 control computer 400 or digital displays 100/200 detect the need for emergency lighting or a power outage or determined the existence of an emergency that may require emergency lighting, as described above. If digital displays 100/200 are used to determine the emergency or detect the need for emergency lighting, digital displays 100/200 would then send a signal to control computer 400 indicating the need for emergency lighting. Once control computer 400 determines there is an emergency and a need for emergency lighting, at Step 710 control computer 400 uses emergency lighting process 570 and sends an emergency lighting signal to digital displays 100/200 instructing digital displays 100/200 to enter emergency lighting mode, as described above. If graphic/video and/or audio directional messages are also to be used, at Step 715 control computer 400 prepares graphics/video 560 information and/or audio 562 information to send to digital displays 100/200. Graphics/video 460 information and/or audio 562 information may be stored in compressed or raw data state, in which case processor 520 can perform decompression or rendering processes to convert the stored data to graphics/video and/or audio. Further, if used in a system such as that shown in FIG. 3, control computer 400 can arrange the graphics/video and/or audio in a buffer with correct order, position, and orientation as required such that the images and/or audio are transmitted to the correct one of digital displays 100/200, taking into account which digital displays 100/200 are connected to which media players 420, and their order on the daisy chain.

Once the graphics/video and/or audio information has been prepared, control computer 400 sends the information at Step 720. If a media player 420 is being used in the system, control computer 400 can send the information to media player 420, via router 410. If media player 420 is not being used, control computer 400 can send the information directly to digital displays 100/200.

At Step 725, once the graphics/video and/or audio information is received, either by media player 420 or digital displays 100/200, the graphics/video to be displayed and/or audio to be broadcast are generated. At Step 730, digital displays 100/200 enter emergency lighting mode, as described above, and display the graphics/video and/or broadcast the audio.

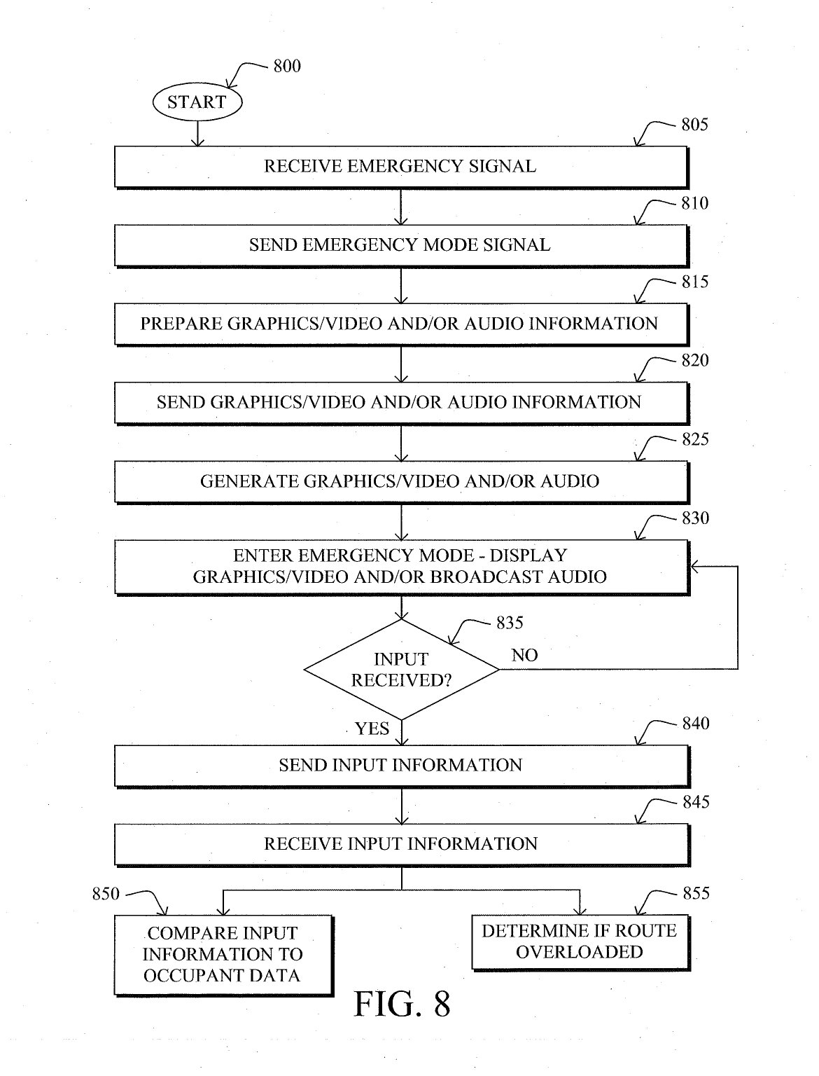

FIG. 8 illustrates an example simplified procedure for operating in fire alarm mode in accordance with one or more embodiments described herein. The example process starts at step 800 and at Step 805 control computer 300 receives a fire alarm or other emergency signal, as described above. At Step 810 control computer 400 uses fire alarm process 575 and sends an emergency mode signal to digital displays 100/200 instructing digital displays 100/200 to enter fire alarm mode, as described above. If graphic/video and/or audio messages are also to be used, such as broadcast messages, emergency instructions, evacuation instructions, etc., at Step 815 control computer 400 prepares graphics/video 560 information and/or audio 562 information to send to digital displays 100/200. Graphics/video 460 information and/or audio 562 information may be stored in compressed or raw data state, in which case processor 520 can perform decompression or rendering processes to convert the stored data to graphics/video and/or audio. Further, if used in a system such as that shown in FIG. 3, control computer 400 can arrange the graphics/video and/or audio in a buffer with correct order, position, and orientation as required such that the images and/or audio are transmitted to the correct one of digital displays 100/200, taking into account which digital displays 100/200 are connected to which media players 420, and their order on the daisy chain.

Once the graphics/video and/or audio information has been prepared, control computer 400 sends the information at Step 820. If a media player 420 is being used in the system, control computer 400 can send the information to media player 420, via router 410.

If media player 420 is not being used, control computer 400 can send the information directly to digital displays 100/200.

At Step 825, once the graphics/video and/or audio information is received, either by media player 420 or digital displays 100/200, the graphics/video to be displayed and/or audio to be broadcast are generated. At Step 830, digital displays 100/200 enter fire alarm mode, as described above, and display the graphics/video and/or broadcast the audio.

If digital displays 100/200 are equipped with touch interfaces or some other input device and are being used to monitor evacuations, etc., the process can continue with Step 835, in which the digital displays 100/200 determine if there has been an input by an occupant, such as selecting a touch target or video of an escape route. If there has not been any occupant input, digital displays 100/200 continue in fire alarm mode at Step 830. If there has been an occupant input, at Step 840, digital displays 100/200 send information regarding the occupant input to control computer 400, either directly or through media players 420, if used.

Control computer 400 receives the input information at Step 845. Based on the input, control computer 400 can take various actions, as described above. For example, at Step 850, control computer 850 can compare the input information received to occupant data 563 to determine if there are still occupants in a building that is being evacuated. In addition, at Step 855, control computer 400 can use the input information, either through occupants selecting a touch target or using a video signal and video analytics, to determine if a particular evacuation route is being overloaded. If control computer 400 determines that a particular evacuation route is overloaded, graphics/video and/or audio can be generated and sent to digital displays 100/200 for display/broadcast that re-routes occupants to optional, less congested evacuation routes using processes such as those described in Steps 815-830 above.

When the density of digital displays in a building approaches a certain minimum, digital displays can become an important safety, security, and or convenience feature and new safety, security, and convenience applications for the digital display network can be enabled, which can provide enhanced safety, convenience, and efficiency. If most parts of an occupied space in a building are within view of a digital display, the network of digital displays can supplement or even replace some of the normal safety and security capabilities traditionally provided by other systems typically found in public buildings. If a relatively large network of interactive digital displays (especially digital displays including reliable power, high output backlights, touch screens, cameras, microphones, speakers, etc.) is included in a building, it may be possible to reduce or even eliminate some of the traditional building networks (including emergency lighting, fire alarm horns, PA speakers, security cameras), greatly reducing construction costs and ongoing operational costs. Building occupants receive much more information in case of an emergency, facilitating faster, safer emergency responses.

It should be noted that while certain steps within the procedures described above may be optional, the steps shown are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while the procedures are described separately, certain steps from each procedure may be incorporated into each other procedure, and the procedures are not meant to be mutually exclusive.

While there have been shown and described illustrative embodiments that provide for emergency digital signage systems and various service modes that can be used with these systems, it is to be understood that various other adaptations and modifications may be made within the spirit and scope of the embodiments herein. The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

1. A system, comprising:
a plurality of digital displays, each digital display being connected to a backup power source; and
a control computer connected to the plurality of digital displays, the control computer comprising a processor and a memory, the memory configured to communicate with the processor and having instructions stored thereon that, in response to execution by the processor, cause the processor to perform operations comprising;
determining the existence of an emergency; and
sending a signal to the plurality of digital displays, the signal including instructions for the plurality of digital displays to enter an emergency mode.

2. The system of claim 1, wherein:
the emergency is a need for emergency lighting; and
the instructions include instructions for the digital displays to increase to a maximum illumination level and display a white screen.

3. The system of claim 2, wherein the instructions, in response to execution by the processor, cause the processor to perform operations further comprising:
preparing at least one of graphics information and audio information, the graphics information and audio information comprising emergency information for communication to a building occupant; and
sending at least one of the graphics information and audio information to the plurality of digital displays; wherein
the plurality of digital displays are configured to display an emergency message based on the graphics information and broadcast an audio emergency message based on the audio information.

4. The system of claim 3, wherein the emergency information comprises at least one of a direction to an emergency exit route, information regarding the nature of an emergency, and emergency evacuation instructions.

5. The system of claim 1, wherein:
the emergency is a fire alarm; and
the signal includes instructions for the digital displays to disable a mute mode and broadcast an alarm tone.

6. The system of claim 5, wherein the instructions, in response to execution by the processor, cause the processor to perform operations further comprising:
preparing at least one of graphics information and audio information, the graphics information and audio information comprising emergency information for communication to a building occupant; and
sending at least one of the graphics information and the audio information to the plurality of digital displays; wherein
the plurality of digital displays are configured to display an emergency message based on the graphics information and broadcast an audio message based on the audio information.

7. The system of claim 6, wherein the emergency information comprises at least one of a broadcast announcement, a strobe effect, text caption instructions, an emergency exit route, and emergency evacuation instructions.

8. The system of claim 5, wherein the instructions, in response to execution by the processor, cause the processor to perform operations further comprising:
receiving an input;
comparing the input to occupant data; and
determining a building occupancy based on the input and the occupant data.

9. The system of claim 5, wherein the instructions, in response to execution by the processor, cause the processor to perform operations further comprising:
receiving an input;
determining if an evacuation route is overloaded based on the input; and
in response to a determination that an evacuation route is overloaded, preparing graphics information, the graphics information comprising information regarding an alternate evacuation route; and
sending the graphics information to the plurality of digital displays; wherein
the plurality of digital displays are configured to display an emergency message based on the graphics information.

10. A system, comprising:
a plurality of digital displays, each digital display comprising a camera; and
a control computer connected to the plurality of digital displays, the control computer comprising a processor and a memory, the memory configured to communicate with the processor and having instructions stored thereon that, in response to execution by the processor, cause the processor to perform operations comprising;
receiving video feeds from the cameras of the plurality of digital displays; and
analyzing the video feeds to detect the presence of occupants.

11. The system of claim 10, wherein the instructions, in response to execution by the processor, cause the processor to perform operations further comprising generating an alert in response to a detection of occupant presence.

12. The system of claim 10, wherein the instructions, in response to execution by the processor, cause the processor to perform operations further comprising generating instructions for a building environmental system in response to a detection of no occupant presence.

13. A method, comprising:
determining the existence of an emergency at a control computer; and
sending a signal from the control computer to a plurality of digital displays, the signal including instructions for the plurality of digital displays to enter an emergency mode.

14. The method of claim 13, wherein:
the emergency is a need for emergency lighting; and
the instructions include instructions for the digital displays to increase to a maximum illumination level and display a white screen.

15. The method of claim 14, further comprising:
preparing at least one of graphics information and audio information using the control computer, the graphics information and audio information comprising emergency information for communication to a building occupant; and
sending at least one of the graphics information and the audio information from the control computer to the plurality of digital displays; wherein
the plurality of digital displays are configured to display an emergency message based on the graphics information and broadcast an audio emergency message based on the audio information.

16. The method of claim 13, wherein:
the emergency is a fire alarm; and
the instructions include instructions for the digital displays to disable a mute mode and broadcast an alarm tone.

17. The method of claim 16, further comprising:
preparing at least one of graphics information and audio information using the control computer, the graphics information and audio information comprising emergency information for communication to a building occupant; and
sending at least one of the graphics information and the audio information from the control computer to the plurality of digital displays; wherein
the plurality of digital displays are configured to display an emergency message based on the graphics information and broadcast an audio message based on the audio information.

18. The method of claim 17, wherein the audio information comprises instructions for each digital display along an evacuation route to broadcast an identifiable sound in sequence along the evacuation route and the plurality of digital displays are configured to broadcast the identifiable sound.

19. The method of claim 17, further comprising:
receiving an input from the digital displays at the control computer;
comparing the input to occupant data using the control computer; and
determining a building occupancy based on the input and the occupant data using the control computer.

20. The method of claim 17, further comprising:
receiving an input from the digital displays at the control computer;
determining if an evacuation route is overloaded based on the input using the control computer; and
in response to a determination by the control computer that an evacuation route is overloaded, preparing graphics information using the control computer, the graphics information comprising information regarding an alternate evacuation route; and
sending the graphics information from the control computer to the plurality of digital displays; wherein
the plurality of digital displays are configured to display an emergency message based on the graphics information.
